(19) United States
(12) Patent Application Publication
(10) Pub. No.: US 2025/0289684 A1
(43) Pub. Date: Sep. 18, 2025

(54) FRICTION RING

(71) Applicant: REYMAK MAKINE SANAYI VE TICARET ANONIM SIRKETI, Yunusemre, MANISA (TR)

(72) Inventor: Ersan ERZI, Yunusemre, MANISA (TR)

(21) Appl. No.: 18/702,591

(22) PCT Filed: Oct. 17, 2022
(86) PCT No.: PCT/TR2022/051150

§ 371 Date: Apr. 18, 2024

(51) Int. Cl. B65H 75/24

(52) U.S. Cl. CPC B65H 75/247

(57) ABSTRACT

Disclosed is a friction ring used for gripping paper, plastic, and steel bobbins in the packaging industry. The friction ring has a body with a cam, a spiral spin groove, and stroke determining groove on its outer surface. A ball that moves is on the cam and locks the bobbin somewhere between the minimum and maximum expanding diameter to ensure the fixing of the bobbin. A synchronous ring is disposed on the body to enable the balls to move synchronously. A wire spring is disposed on the inner surface of the synchronous ring to provide tension on the ball to ensure the bobbin builds a unit with the synchronous ring and rotates on the body with minimum friction.

### TECHNICAL FIELD

The invention relates to a friction ring used for gripping paper, plastic and steel bobbins in the packaging industry.

### PRIOR ART

Friction rings are used in the packaging industry to grip paper, plastic and steel bobbins. In general, materials such as paper are wound on a cylindrical paper tube and the bobbins are fixed on friction rings while the said materials are wound on paper, plastic, steel bobbins through an automatic production line or when unwinding and/or using the wound material for further processing.

The friction rings used in the present technique are traditionally comprised of closed circuit body and ring form. These closed-circuit friction rings cause difficulty in use due to the contact of the paper bobbin dust on which it works during operation with the inside parts of the springs located between the synchronous ring and the body. In order to clean the paper bobbin dust, the friction ring is completely disassembled and the dust underneath the flat springs is cleaned with compressed air. Therefore, this leads to losses in labor and time. Another problem of the presently used friction rings is that the springs that provide tension on the balls that enable the roller to rotate are located on the body. Because of this, rings with a single or double row of springloaded balls must be produced and used separately according to the spring positioning. This is a situation that causes difficulties in production. In addition to this, steel flat springs are changed at certain time intervals. For this reason, a need has arisen to eliminate the problems experienced in friction rings in the present state of the art.

The document KR102154783B1 can be shown as an example of the known state of the art that was found in the research conducted in the literature. The said document relates to a friction ring with increased durability. In the said invention, at least one ball bearing is placed between the inner circumferential surface of the lug housing and the inner circumferential surface of the lug housing and the outer circumferential surface of the rotating shaft, so that the outer circumferential surface of the rotary shaft, the inner circumferential surface of the flange socket and the outer circumferential surface of the rotary shaft rotate independently of each other.

Here, the friction ring rotates with the piston housing. The said friction ring is resistant to abrasion and prevents damages such as tearing of sheet products by stopping the rotation of the paper tube in cases where wrapping of paper products is difficult due to tangling and similar reasons.

Therefore, due to the presence of the problems described above and the inadequacy of the solutions to meet the needs, it is required to make an improvement in the relevant technical field.

### PURPOSE OF THE INVENTION

The present invention relates to a friction ring that eliminates the disadvantages mentioned above and provides some new additional advantages in the related technical field.

The main purpose of the invention is to provide a friction ring that can be cleaned without disassembly by means of its laterally open structure.

The purpose of the invention is to provide a friction ring with a long-lasting structure by means of the use of wire springs.

Another purpose of the invention is to provide a friction ring that provides ease of use.

Another purpose of the invention is to provide a friction ring that provides operation in all functions with the pre-centering option in both unidirectional and bidirectional rings, by means of the positioning of the wire springs that provide tension on the balls on the ring.

Another purpose of the invention is to provide a friction ring that can start clamping in the lower, middle and upper positions of the balls working unidirectionally and bidirectionally with a single synchronous ring.

Another purpose of the invention is to provide a friction ring that is suitable for winding tear-sensitive materials by minimizing the internal friction between the body and the synchronous ring. This is achieved with the removal of flat springs used in conventional friction rings, where the body and the synchronous ring were in permanent contact to each other and thereby created an internal friction that was not appropriate for the rewinding of tear-sensitive materials that need to be wound with very low or no air pressure applied to the friction shaft body, that carries the friction rings. In order to achieve the objects specified above and those that may come about from the detailed description, the invention is a friction ring used for gripping paper, plastic, steel bobbins in the packaging industry, characterized by comprising;
a body comprising a cam, a spiral spring groove and stroke determining groove on its outer surface,
a ball that moves on the cam and locks the bobbin at the opening diameter and ensures the rotation of the bobbin,
a synchronous ring, disposed on the body and enabling the balls to move synchronously,
a wire spring, disposed on the inner surface of the synchronous ring that provides tension on the ball to ensure that the bobbin runs on the synchronous ring without friction.

The structural and characteristic features of the invention and all its advantages will be understood more clearly by means of the figures presented below and the detailed description written by reference to these figures. For this reason, the evaluation should be made by considering these figures and the detailed description.

### FIGURES TO HELP UNDERSTANDING OF THE INVENTION

FIG. 1: is the front view of the friction ring, which is the subject of the invention.

FIG. 2: is the cross-sectional view of the friction ring, which is the subject of the invention.

FIG. 3: is the detail view of the friction ring, which is the subject of the invention.

FIG. 4: is the perspective view of the body of the friction ring, which is the subject of the invention.

FIG. 5: is the perspective view of the synchronous ring of the friction ring, which is the subject of the invention.

### DESCRIPTION OF PART REFERENCES

10. Body
11. Cam
12. Spiral spring groove
13. Stroke determining groove
20. Synchronous ring
30. Bal
40. Wire spring
50. Stroke screw
60. Spiral spring screw

### DETAILED DESCRIPTION OF THE INVENTION

In this detailed description, the preferred configurations of the friction ring, which is the subject of the invention, are explained only for a better understanding of the subject and without causing any limiting effect.

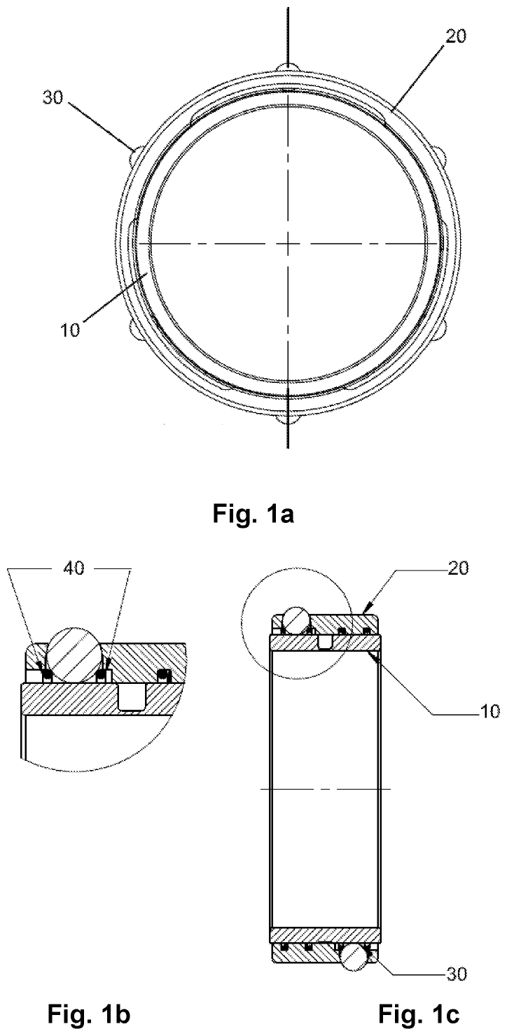

The views of the friction ring subject to the invention are given In FIGS. 1a, 1b and 1c. Accordingly, the friction ring in its most basic form comprises a circular body (10), a synchronous ring (20) disposed on the body (10), a ball (30) that moves on the cam (11) disposed on the outer surface of the body (10) that locks to the bobbin at a diameter somewhere between the min. and max. expanding diameters, allowing the bobbin to rotate as a unit with the friction ring, a wire spring (40) positioned on the inner surface of the synchronous ring (20) and providing tension on the ball (30) to ensure that the bobbin is fixed on the synchronous ring (20) a stroke screw (50) located on the synchronous ring (20) that restricts the movement distance by acting as a limitation on the total expanding range of the ball (30), a spiral spring screw (60) positioned in the spiral spring groove (12) on the body (10) that determines the position where the wire spring (40) will be held and that enables the synchronous ring (20) to start clamping in the lower, middle, and upper positions of the balls and enables all functions that result thereof.

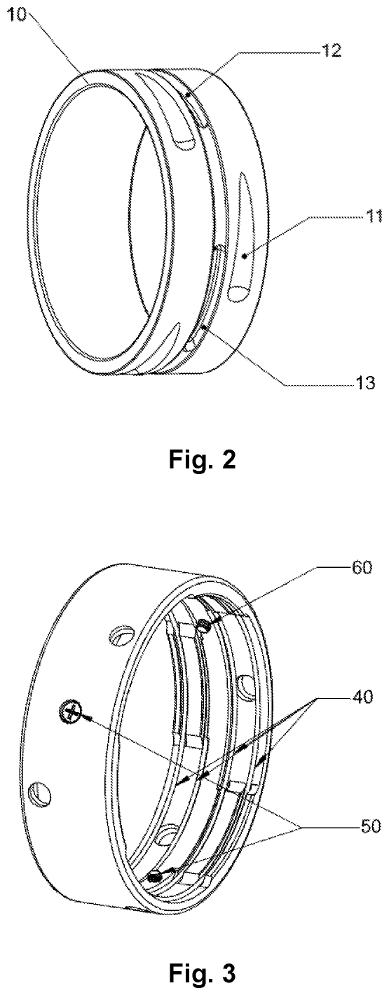

The body (10) that forms the main structure of the friction ring, which is the subject of the invention, determines the working function of the friction ring. As seen in FIG. 2, there are cams (11), spiral spring groove (12) and stroke determining groove (13) on the outer surface of the body (10), which determine the total expanding range of the balls (30). The said balls (30) move on the cam (11) and fix the bobbin somewhere between the min. and max. expanding diameters and ensure the rotation of the bobbin as a unit with the friction ring.

As seen in FIG. 3, the wire spring (40) is placed on the inner surface of the synchronous ring (20), which enables the balls (30) to move synchronously. The said wire springs (40) provide tension on the ball (30) in order to ensure that the bobbin is fixed on the synchronous ring (20) which due to the lack of flat springs, rotates on the body with min. friction. This aims at minimizing the internal friction of the friction ring allowing very tear-sensitive materials to be wound as well.

The position where the balls (30) will be held on the cam (11) is determined by the spiral spring screw (60), which is positioned in the spiral spring groove (12) on the body (10). Thus, the synchronous ring (20) is enabled to start clamping in the lower, middle and upper position of the balls

The stroke determining groove (13) disposed on the outer surface of the body (10) serves as the stopper groove that enables the friction ring to operate between open and closed diameters. There is a stroke screw (50) on the synchronous ring (20) that limits the stroke distance by acting as a limiter in the open and closed diameters of the balls (30).

1. A friction ring used for gripping paper, plastic, steel bobbins in the packaging industry, the friction ring comprising:
a body comprising a cam, a spiral spring groove and a stroke determining groove on its outer surface,
a ball that moves on the cam and locks the bobbin at an opening diameter and ensures rotation of the bobbin,
a synchronous ring, disposed on the body and enabling the balls to move synchronously, and
a wire spring, disposed on the inner surface of the synchronous ring that provides tension on the ball to ensure that the bobbin runs on the synchronous ring without friction.

2. The friction ring according to claim 1, further comprising a stroke screw disposed on the said synchronous ring that restricts the stroke distance by acting as a limitation on the open and closed diameters of the ball.

3. The friction ring according to claim 1, further comprising-a spiral spring screw, disposed in the spiral spring groove on the body that determines the position where the ball will be held, enabling the synchronous ring to start clamping in the lower, middle and upper position of the balls and enables all functions resulting thereof.
